(19) United States
(12) Patent Application Publication
(10) Pub. No.: US 2011/0084065 A1
(43) Pub. Date: Apr. 14, 2011

(54) Slidable Tray Assembly for Microwave Oven

(76) Inventors: Charles Gibson, Hackettstown, NJ (US); Dolleva Rogers, Brooklyn, NY (US)

(21) Appl. No.: 12/787,033

(22) Filed: May 25, 2010

Related U.S. Application Data
(63) Continuation-in-part of application No. 12/706,830, filed on Feb. 17, 2010.
(60) Provisional application No. 61/250,178, filed on Oct. 9, 2009.

(51) Int. Cl. H05B 6/64

(52) U.S. Cl. 219/756; 219/763

(57) ABSTRACT

According to at least one embodiment, a slidable tray assembly for a microwave oven is disclosed. The slidable tray assembly includes a base portion having a size configured to fit within the interior cavity of a microwave oven, a sliding portion configured for slidable cooperation with the base portion, a plurality of side walls coupled to and extending vertically from the sliding portion, a handle, and at least one slide stopper.

### RELATED PATENT APPLICATIONS

The present invention is a continuation-in-part application of U.S. patent application Ser. No. 12/706,830 filed Feb. 17, 2010, which claims benefit of U.S. Provisional Patent Application No. 61/250,178, filed on Oct. 9, 2009, the disclosures of which are incorporated by reference herein in their entireties.

### BACKGROUND

Microwave ovens are widely utilized as a fast and convenient method of heating and cooking food and liquids. While a microwave oven may heat and cook food more rapidly than a conventional convection oven, the food may frequently cooked unevenly, leaving undesirable hot and cold spots in the food. Certain microwave ovens known in the art provide a rotatable turntable to facilitate evenly distributing heat throughout the food. Yet even when utilizing a turntable, hot and cold spots may remain in the food, and some foods may need frequent stirring to ensure that they are cooked evenly. However, the front-loading configuration and horizontal orientation of most microwave ovens does not allow the user enough space to conveniently and safely access the food while it is in the oven.

Moreover, withdrawing and replacing the food from the oven may be cumbersome and carry risk of burn or injury. Dishes placed in the microwave are frequently hot and require careful handling when the user desires to withdraw the dish from the oven. Additionally, handling dishes containing liquids carries with it the risk of spillage of hot liquid, which may be exacerbated by the weight of the dish and its contents.

### SUMMARY

According to at least one embodiment, a slidable tray assembly for a microwave oven is disclosed. The slidable tray assembly includes a base portion having a size configured to fit within the interior cavity of a microwave oven, a sliding portion configured for slidable cooperation with the base portion, a plurality of side walls coupled to and extending vertically from the sliding portion, a handle, and at least one slide stopper.

According to another exemplary embodiment, a sliding tray for a microwave oven can include a sliding portion having a size configured to fit within the interior cavity of a microwave oven, an aperture defined in the sliding portion; a recess defined in the top surface of the sliding portion, a rotatable turntable, the turntable further comprising a tray portion and a support portion, and a spline member, the spline member configured to pass through the aperture, to engage the support portion and to disengageably couple with a turntable driving mechanism of the microwave oven.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1a is an exemplary diagram of a microwave oven having a slidable tray assembly.

FIG. 1b is an exemplary diagram of a disassembled slidable tray assembly.

FIG. 1c is an exemplary diagram of a slide stopper.

FIG. 2a is an exemplary diagram of a microwave oven having a slidable tray assembly with a turntable.

FIG. 2b is an exemplary diagram of a microwave oven with the slidable tray assembly with a turntable withdrawn.

FIG. 2c is an exemplary diagram of a turntable for an exemplary embodiment of a slidable tray assembly.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the method, system or apparatus include the discussed feature, advantage or mode of operation.

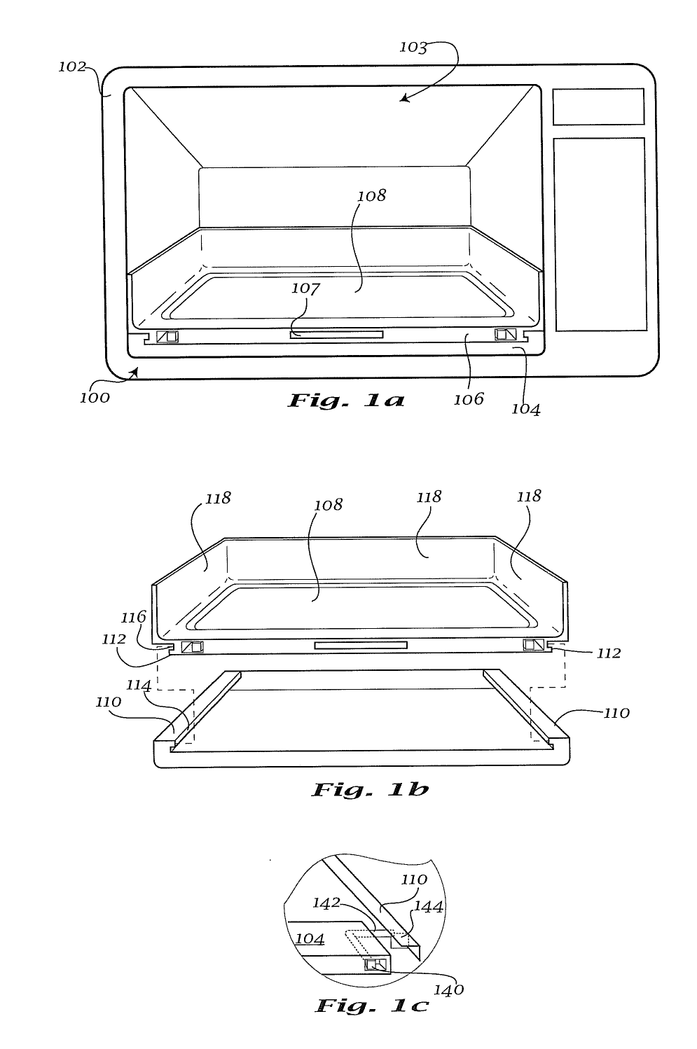

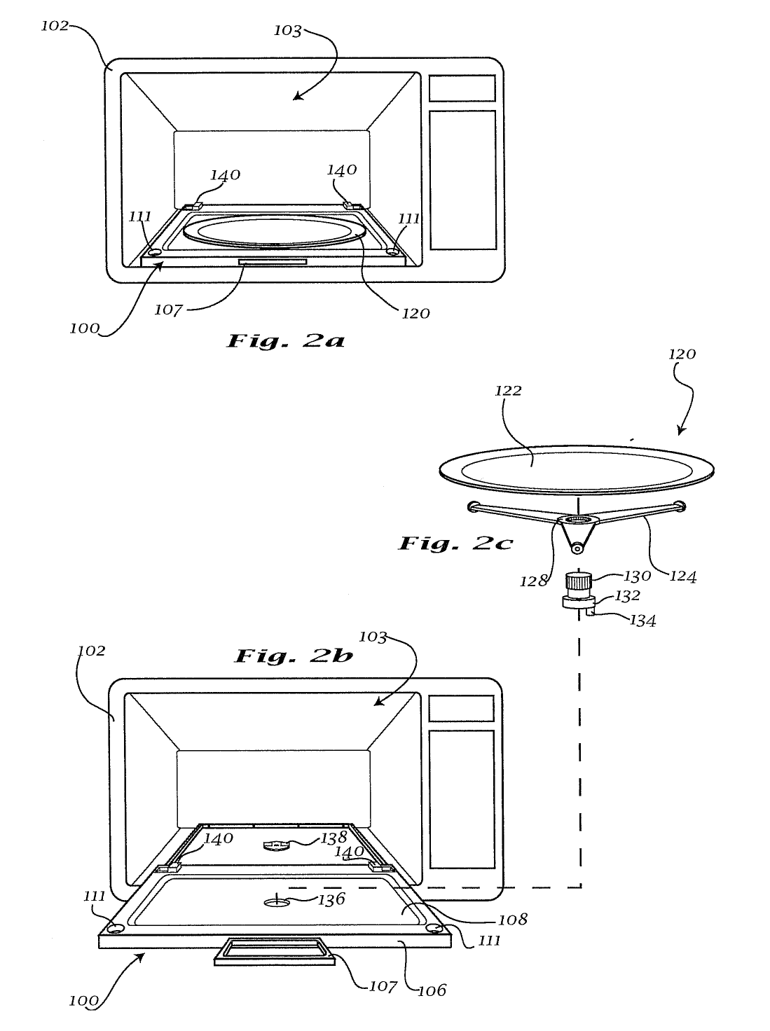

Generally referring to FIGS. 1a-2c, a slidable tray assembly for a microwave including an apparatus, method and system, is disclosed. The slidable tray assembly 100 may be of a size configured to fit within the interior cavity 103 of a microwave 102. In one embodiment, the slidable tray assembly may include a rotatable turntable 120. Slidable tray ssembly 100 may be constructed of plastic, glass, heat-resistant glass, or any other microwave-safe material known to one having ordinary skill in the art.

Turning to FIGS. 1a-1c, slidable tray assembly 100 may be substantially rectangular in shape and may include a base portion 104 and a sliding portion 106. Base portion 104 may have a length and a width such that base portion 104 may be received within the interior cavity 103 of a microwave 102. Interior cavity 103 may have dimensions substantially similar to industry standard microwave dimensions, or any other commonly used dimensions known in the art. Base portion 104 may further be sized to facilitate receiving base portion 104 within interior cavity 103 such that the space between the edges of base portion 104 and the walls of interior cavity 103 is minimized. Sliding portion 106 can also have a thickness or structural members that impart sliding portion 106 with structural rigidity that is substantially sufficient to inhibit flexing of sliding portion 106. Sliding portion 106 may facilitate supporting food items, while base portion 104 may aid the user in balancing and slidably withdrawing assembly 100 from interior cavity 103 of microwave oven 102, as well as counterbalancing a load placed onto sliding portion 106 when it is withdrawn from interior cavity 103.

Base portion 104 may be coupled to the walls of interior cavity 103 of microwave oven 102. Such coupling may be facilitated via adhesives, such as, for example, glue, epoxy, or any other adhesive known in the art that is capable of withstanding sustained exposure to microwave radiation. Such coupling may also be facilitated mechanically via screws, bolts, or any other fastener known in the art that allows slidable tray assembly 100 to function as described herein. Base portion 104 may further include at least one slide rail 110 therein. At least one slide rail 110 may be formed integral with base portion 104 or may be coupled thereto adhesively or mechanically, utilizing, for example, glues, epoxies, screws, bolts, or any other adhesive or fastener known in the art. Sliding portion 106 may further include at least one corresponding slide rail 112 on the bottom thereof. At least one corresponding slide rail 112 may be formed integral with sliding portion 106 or may be coupled thereto adhesively or mechanically, utilizing, for example, glues, epoxies, screws, bolts, or any other adhesive or fastener known in the art.

At least one slide rail 110 and at least one corresponding slide rail 112 may engage each other and cooperate to facilitate slidably withdrawing sliding portion 106 from interior cavity 103. Slide rails 110, 112 may have a tongue-and-groove configuration as shown in FIGS. 1a-1b, wherein a tongue 114 of rail 110 may engage groove 116 of corresponding rail 112 and vice-versa. In other embodiments, slide rails 110, 112 may be any type of linear slide apparatus known to one having ordinary skill in the art and manufactured from any microwave-safe material known to one having ordinary skill in the art. Slide rails 110, 112 may also include ball bearings, a Teflon coating, or any friction-reducing means known to one having ordinary skill in the art.

In another exemplary embodiment, at least one slide rail 112 may have a plurality of teeth defined in the surface thereof, and may, in a rack-and-pinion arrangement, engage a gear (not shown) rotatably coupled to base portion 104. Similarly, at least one slide rail 110 may have a plurality of teeth defined in the surface thereof, and may, in a rack-and-pinion arrangement, engage at least one gear (not shown) rotatably coupled to sliding portion 106. Said gears may include dampening mechanisms to facilitate smoothly withdrawing sliding portion 106 from interior cavity 103. In certain embodiments, said gears may be operatively coupled to a motor or other motive device to facilitate automatically withdrawing sliding portion 106 from interior cavity 103.

Sliding portion 106 may include a recess 108 defined in the top surface thereof. Recess 108 may facilitate maintaining food items within recess 108 during movement of sliding portion 106 in and out of interior cavity 103. In other exemplary embodiments, the top surface of sliding portion 106 may be flat to facilitate accommodating large food items on the top surface of sliding portion 106.

Sliding portion 106 may also include rear and side walls 118 disposed at the edges thereof and extending vertically therefrom. Side walls 118 may facilitate maintaining crumbs or small foodstuffs within sliding portion 106. Side walls 118 may likewise reduce the likelihood of crumbs or small foodstuffs passing into base portion 104, slide rails 110, 112 or interior cavity 103.

In one exemplary embodiment, sliding portion 106 of slidable tray assembly 100 may include a handle 107 to facilitate withdrawing sliding portion 106 from cavity 103. Handle 107 may be defined in the surface of and integral with sliding portion 106. In one exemplary embodiment, handle 107 may be movably mounted within a housing defined within sliding portion 106 such that the user may withdraw the handle by pulling thereon, and withdraw sliding portion 106 by pulling on handle 107 when handle 107 is fully withdrawn. In another exemplary embodiment, handle 107 may include a mechanism operating on a push-to-close and push-to-open principle, such that the user may depress handle 107 inward to withdraw handle 107 from the housing and may likewise depress handle 107 inward to replace and latch handle 107 within the housing. In other exemplary embodiments, handle 107 may be defined as at least one aperture 111 in sliding portion 106.

In one exemplary embodiment, slidable tray assembly 100 may include at least one slide stopper 140. Slide stopper 140 may be selectively actuated by a user to avoid sliding tray assembly 100 past a desired point on slide rails 110, 112, thereby increasing safety and reducing the likelihood of spillage, tipping over of the microwave oven, or similar incidents. Actuation of stopper 140 may be, for example, positioning stopper 140 such that a member 142 of stopper 140 interfaces with a tab 144 or a plurality of tabs 144 to prevent further withdrawal of tray assembly 100 from cavity 103. In one embodiment, stopper 140 may be disposed within sliding portion 106 while tab 144 may be disposed within base portion 104. In another embodiment, stopper 140 may be disposed within base portion 104 while tab 144 may be disposed within sliding portion 106.

Turning to FIGS. 2a-2c, in one exemplary embodiment, slidable tray assembly 100 may include a rotatable turntable 120. Rotatable turntable 120 may include a tray portion 122 and a support portion 124. Support portion 124 may include wheels 126 rotatably coupled to support portion 124 and movably engaged with sliding portion 106 of slidable tray assembly 100. Support portion 124 may also include a center hub 128 configured to engage a spline member 130 of slidable tray assembly 100. Support portion 124 may thus facilitate supporting and rotating tray portion 122 around its center.

Spline member 130 may be rotatably coupled to slidable tray assembly 100 and may pass through an aperture 136 defined center of sliding portion 106. Aperture 136 may be defined in a location of sliding portion 106 such that when slidable tray assembly 100 is disposed fully within cavity 103, aperture 136 is located substantially above a turntable driving mechanism 138 of microwave oven 102. The upper end of spline member 130 may engage center hub 128 of turntable support portion 124 and the lower end of spline member 130 may engage turntable driving mechanism 138. The lower end of spline member 130 may also be configured to engage and disengage turntable-driving mechanism 138 of microwave oven 102 such that slidable tray assembly 100 may be easily withdrawn out of and replaced into cavity 103 of microwave oven 102. For example, lower end of spline member 130 may include a wheel 132 with at least one eccentric nub 134 that may be engaged by at least one tooth on turntable driving mechanism 138 of microwave oven 102.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A slidable tray assembly for a microwave oven, comprising:
a base portion having a size configured to fit within the interior cavity of a microwave oven;
a sliding portion configured for slidable cooperation with the base portion;
a plurality of side walls coupled to and extending vertically from the sliding portion;
a handle; and
at least one slide stopper.

2. The slidable tray assembly of claim 1, further comprising:
at least one first slide rail coupled to the sliding portion; and
at least one second slide rail coupled to the base portion and in slidable cooperation with the at least one first slide rail.

3. The slidable assembly of claim 2, wherein:
the at least one first slide rail is integral with the sliding portion; and
the at least one second slide rail is integral with the base portion.

4. The slidable tray assembly of claim 1, further comprising:
at least one slide rail coupled to the sliding portion and having a plurality of teeth defined in the surface thereof; and
at least one gear rotatably coupled to the base portion and configured to engage the teeth of the at least one slide rail.

5. The slidable tray assembly of claim 1, further comprising:
at least one slide rail coupled to the base portion and having a plurality of teeth defined in the surface, thereof; and
at least one gear rotatably coupled to the sliding portion and configured to engage the teeth of the at least one slide rail.

6. The slidable tray assembly of claim 5, further comprising a motor operatively coupled to the gear.

7. The slidable tray assembly of claim 1, wherein the slide stopper is disposed within the sliding portion.

8. The slidable tray assembly of claim 7, wherein the slide stopper engages a portion of the base portion so as to inhibit movement of the slidable tray assembly.

9. The slidable tray assembly of claim 8, wherein the slide stopper engages a tab defined in the base portion so as to inhibit movement of the slidable tray assembly.

10. The slidable tray assembly of claim 1, wherein the slide stopper is disposed within the base portion.

11. The slidable tray assembly of claim 10, wherein the slide stopper engages a portion of the sliding portion so as to inhibit movement of the slidable tray assembly.

12. The slidable tray assembly of claim 11, wherein the slide stopper engages a tab defined in the sliding portion so as to inhibit movement of the slidable tray assembly.

13. The slidable tray assembly of claim 1, wherein the handle further comprises an aperture defined in the horizontal portion of the slidable tray assembly.

14. The slidable tray assembly of claim 1, wherein the handle is movable with respect to said vertical portion.

15. A method of utilizing a microwave oven, comprising:
withdrawing a slidable tray from the interior cavity of the microwave oven;
placing a food item onto the top surface of the slidable tray;
replacing the slidable tray into the interior cavity of the microwave oven; and
operating the microwave oven.

16. The method of claim 15, wherein the slidable tray assembly further comprises a base portion disposed in the interior cavity of the microwave oven and a sliding portion configured for slidable cooperation with the base portion.

17. The method of claim 15, further comprising inhibiting movement of the sliding portion by actuating a slide stopper.

18. The method of claim 15, further comprising rotating the food item on a rotatable turntable disposed on the top surface of the slidable tray.
